(19) United States
(12) Patent Application Publication
(10) Pub. No.: US 2016/0129350 A1
(43) Pub. Date: May 12, 2016

(54) METHOD AND SYSTEM FOR EVOLVING AN AVATAR

(71) Applicant: THOMSON LICENSING, ISSY LES MOULINEAUX (FR)

(72) Inventor: Jagjeet Singh KHALSA, San Diego, CA (US)

(21) Appl. No.: 14/895,230

(22) PCT Filed: Aug. 2, 2013
(86) PCT No.: PCT/US2013/053413

§ 371 Date: Dec. 2, 2015

Related U.S. Application Data
(60) Provisional application No. 61/833,033, filed on Jun. 10, 2013.

(51) Int. Cl. A63F 13/58; A63F 13/69

(52) U.S. Cl. CPC A63F 13/58; A63F 13/69

(57) ABSTRACT

A method and system are provided for evolving an avatar. The method includes accessing a user profile for a user from a memory device. The method further includes generating an avatar for the user based upon the user profile. The method also includes changing the user profile based upon actions of the user relating to at least one of experience based progression, content type progression, frequency based progression, and competition based progression. The method additionally includes evolving an attribute of the avatar based upon a change in the user profile.

### CROSS-REFERENCE TO RELATED APPLICATIONS

This application claims the benefit of U.S. Provisional Application Ser. No. 61/833,033 (Attorney Docket No. PU130079), filed Jun. 10, 2013, which is incorporated by reference herein in its entirety.

### TECHNICAL FIELD

The present principles relate generally to avatars and, more particularly, to a method and system for providing an evolving avatar.

### BACKGROUND

Avatars are used for products such as Xbox Live ^{TM} where users can purchase different clothing or objects which are shown for their avatars. However, avatars are typically static in all regards, which can become boring for the user to which the avatar corresponds.

### SUMMARY

These and other drawbacks and disadvantages of the prior art are addressed by the present principles, which are directed to a method and system for providing an evolving avatar.

According to an aspect of the present principles, there is provided a method. The method includes accessing a user profile for a user from a memory device. The method further includes generating an avatar for the user based upon the user profile. The method also includes changing the user profile based upon actions of the user relating to at least one of experience based progression, content type progression, frequency based progression, and competition based progression. The method additionally includes evolving an attribute of the avatar based upon a change in the user profile.

According to another aspect of the present principles, there is provided a system. The system includes a memory device for storing a user profile for a user. The system further includes an avatar generator for generating an avatar for the user based upon the user profile. The system also includes a user profile manager for changing the user profile based upon actions of the user relating to at least one of experience based progression, content type progression, frequency based progression, and competition based progression. The system additionally includes an avatar evolver for evolving an attribute of the avatar based upon a change in the user profile.

According to yet another aspect of the present principles, there is provided a non-transitory computer readable storage medium having computer executable code stored thereon for performing a method. The method includes accessing a user profile for a user. The method further includes generating an avatar for the user based upon the user profile. The method also includes changing the user profile based upon actions of the user relating to at least one of experience based progression, content type progression, frequency based progression, and competition based progression. The method additionally includes evolving an attribute of the avatar based upon a change in the user profile.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 shows an exemplary system 100 for delivering video content to which the present principles may be applied, in accordance with an embodiment of the present principles;

FIG. 2 shows an exemplary processing system 200 to which the present principles may be applied, according to an embodiment of the present principles, is shown;

FIG. 3 shows an exemplary system 300 for providing an evolving avatar, in accordance with an embodiment of the present principles; and

FIG. 4 shows an exemplary method 400 for providing an evolving avatar, in accordance with an embodiment of the present principles.

### DETAILED DESCRIPTION

The present principles are directed to a method and system for providing an evolving avatar. In an embodiment, the evolving avatar is a representation of a user. In an embodiment, the avatar changes appearance according to the activity/actions of the user. Advantageously, when the evolving avatar is used with respect to an application or a service, the capability of the avatar to evolve will further engage the user to use the application or service more frequently. In an embodiment, the evolving avatar is essentially a “graphical profile” of a user. Thus, instead of relying on a static textual profile of a user, the present principles advantageously provide a graphical representation of a user as an evolving avatar. The avatar can be used in any visual media presentation, including games, television, and so forth. In an embodiment, the avatar can be used as a representation of the user and, thus, in place of the user where permissible. Moreover, in an embodiment, the avatar can interact with other avatars depending upon the implementation. For example, a gaming environment would be a suitable environment for such avatar interaction.

These and other uses of an avatar implemented in accordance with the present principles are readily contemplated by one of ordinary skill in the art, given the teachings of the present principles provided herein, while maintaining the spirit of the present principles.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Initially, a system for delivering various types of content to a user will be described.

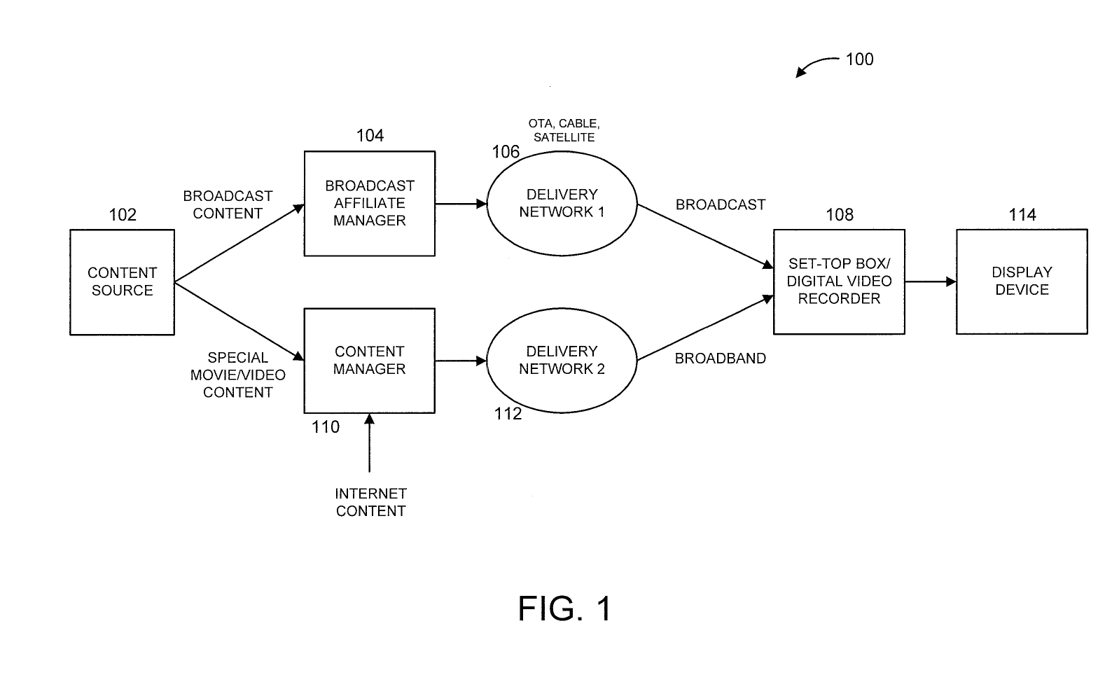

FIG. 1 shows an exemplary system 100 for delivering video content to which the present principles may be applied, in accordance with an embodiment of the present principles. The content originates from a content source 102, such as a movie studio or production house. The content may be supplied in at least one of two forms. One form may be a broadcast form of content. The broadcast content is provided to the broadcast affiliate manager 104, which is typically a national broadcast service, such as the American Broadcasting Company (ABC), National Broadcasting Company (NBC), Columbia Broadcasting System (CBS), etc. The broadcast affiliate manager may collect and store the content, and may schedule delivery of the content over a deliver network, shown as delivery network 1 (106). Delivery network 1 (106) may include satellite link transmission from a national center to one or more regional or local centers. Delivery network 1 (106) may also include local content delivery using local delivery systems such as over the air broadcast, satellite broadcast, or cable broadcast. The locally delivered content is provided to a user's set top box/digital video recorder (DVR) 108 in a user's home, where the content will form part of the results of subsequent searches by the user.

A second form of content is referred to as special content. Special content may include content that may have been delivered as premium viewing, pay-per-view, or other content otherwise not provided to the broadcast affiliate manager. In many cases, the special content may be content requested by the user. The special content may be delivered to a content manager 110. The content manager 110 may be a service provider, such as an Internet website, affiliated, for instance, with a content provider, broadcast service, or delivery network service. The content manager 110 may also incorporate Internet content into the delivery system, or explicitly into the search only such that content may be searched that has not yet been delivered to the user's set top box/digital video recorder 108. The content manager 110 may deliver the content to the user's set top box/digital video recorder 108 over a separate delivery network, delivery network 2 (112). Delivery network 2 (112) may include high-speed broadband Internet type communications systems. It is important to note that the content from the broadcast affiliate manager 104 may also be delivered using all or parts of delivery network 2 (112) and content from the content manager 110 may be delivered using all or parts of Delivery network 1 (106). In addition, the user may also obtain content directly from the Internet via delivery network 2 (112) without necessarily having the content managed by the content manager 110.

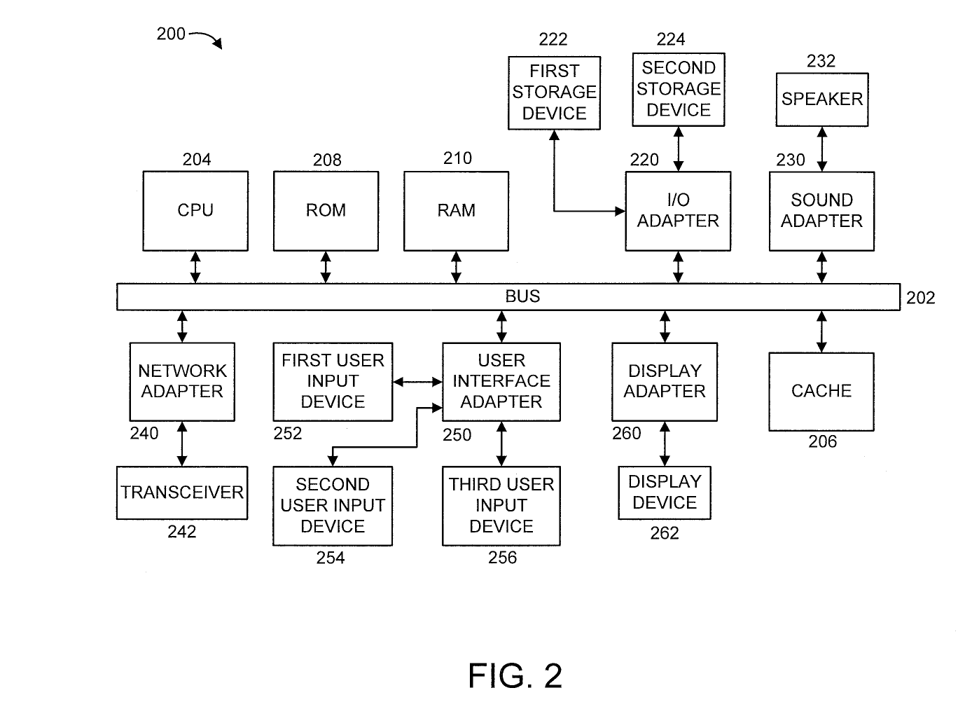

The set top box/digital video recorder 108 may receive different types of content from one or both of delivery network 1 and delivery network 2. The set top box/digital video recorder 108 processes the content, and provides a separation of the content based on user preferences and commands. The set top box/digital video recorder may also include a storage device, such as a hard drive or optical disk drive, for recording and playing back audio and video content. The processed content is provided to a display device 114. The display device 114 may be a conventional 2-D type display or may alternatively be an advanced 3-D display. It should be appreciated that other devices having display capabilities such as wireless phones, PDAs, computers, gaming platforms, remote controls, multi-media players, or the like, may employ the teachings of the present disclosure and are considered within the scope of the present disclosure. In some embodiments, at least display device 114, and in other embodiments, also set top box/digital video recorder 108, can be replaced by a processing system having a display such as processing system 200 shown and described with respect to FIG. 2. The processing system 200 can be representative of any media consumption/presentation device.

FIG. 2 shows an exemplary processing system 200 to which the present principles may be applied, according to an embodiment of the present principles, is shown. The processing system 200 includes at least one processor (CPU) 204 operatively coupled to other components via a system bus 202. A cache 206, a Read Only Memory (ROM) 208, a Random Access Memory (RAM) 210, an input/output (I/O) adapter 220, a sound adapter 230, a network adapter 240, a user interface adapter 250, and a display adapter 260, are operatively coupled to the system bus 202.

A first storage device 222 and a second storage device 224 are operatively coupled to system bus 202 by the I/O adapter 220. The storage devices 222 and 224 can be any of a disk storage device (e.g., a magnetic or optical disk storage device), a solid state magnetic device, and so forth. The storage devices 222 and 224 can be the same type of storage device or different types of storage devices.

A speaker 232 is operative coupled to system bus 202 by the sound adapter 230.

A transceiver 242 is operatively coupled to system bus 202 by network adapter 240.

A first user input device 252, a second user input device 254, and a third user input device 256 are operatively coupled to system bus 202 by user interface adapter 250. The user input devices 252, 254, and 256 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 252, 254, and 256 can be the same type of user input device or different types of user input devices. The user input devices 252, 254, and 256 are used to input and output information to and from system 200.

A display device 262 is operatively coupled to system bus 202 by display adapter 260.

Of course, the processing system 200 may also include other elements (not shown), as readily contemplated by one of skill in the art, as well as omit certain elements. For example, various other input devices and/or output devices can be included in processing system 200, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 200 are readily contemplated by one of ordinary skill in the art given the teachings of the present principles provided herein.

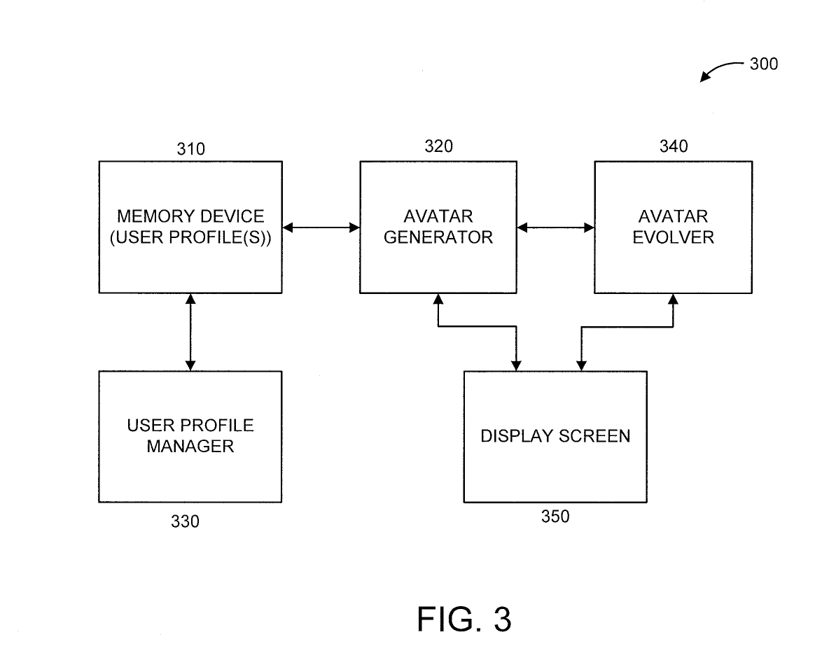

Moreover, it is to be appreciated that system 300 described below with respect to FIG. 3 is a system for implementing respective embodiments of the present principles. Part or all of processing system 200 may be implemented in one or more of the elements of system 300.

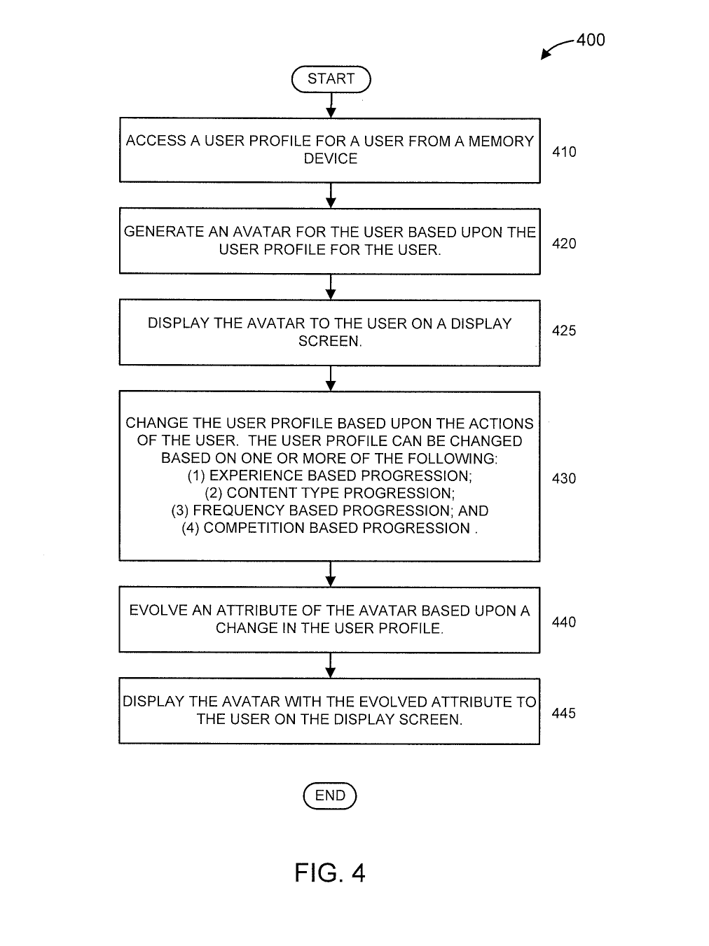

Further, it is to be appreciated that processing system 200 may perform at least part of the method described herein including, for example, at least part of method 400 of FIG. 4. Similarly, part or all of system 300 may be used to perform at least part of method 400 of FIG. 4.

FIG. 3 shows an exemplary system 300 for providing an evolving avatar, in accordance with an embodiment of the present principles. The system 300 includes a memory device 310, an avatar generator 320, a user profile manager 330, an avatar evolver 340, and a display screen 350.

The memory device 310 stores a user profile for a user. The avatar generator 320 generates an avatar for the user based upon the user profile. The display screen 350 displays the avatar to the user. The user profile manager 330 changes the user profile based upon at least one of actions of the user relating to at least one of experience based progression, content type progression, frequency based progression, and competition based progression. The avatar evolver 340 evolves an attribute of the avatar based upon a change in the user profile. The display screen 350 displays the avatar with the evolved attribute to the user. In an embodiment, the user can interact with the avatar.

It is to be appreciated that while the memory device 310 is described as essentially storing one user profile, in other embodiments the memory device 310 can store multiple profiles for a single user or one or more profiles corresponding to different users.

While the display screen 350 is shown as part of the system 300 in FIG. 3, in other embodiments the system 300 may simply interact with the display screen 350, which can be part of a different system or device (such as a content consumption or content presentation device). Moreover, in an embodiment, the entirety of system 300 is part of a content consumption or content presentation device. Further, in other embodiments, one or more of the elements of system 300 can be distributed for use by more than one content consumption or content presentation device. Also, in an embodiment, one or more of the elements of system 300 can be part of a gaming device. These and other variations of the elements of FIG. 3 are readily determined by one of ordinary skill in the art, given the teachings of the present principles provided herein, while maintaining the spirit of the present principles.

FIG. 4 shows an exemplary method 400 for providing an evolving avatar, in accordance with an embodiment of the present principles.

At step 410, access a user profile for a user from a memory device.

At step 420, generate an avatar for the user based upon the user profile for the user.

At step 425, display the avatar to the user on a display screen.

At step 430, change the user profile based upon the actions of the user. In an embodiment, the user profile can be changed based upon at least one of experience based progression, content type progression, frequency based progression, and competition based progression. All of these types of progression are described in further detail herein below.

At step 440, evolve an attribute of the avatar based upon a change in the user profile.

At step 445, display the avatar with the evolved attribute to the user on the display screen.

In an embodiment, the present principles use an evolving avatar to further engage a user to watch the content in which the avatar is implemented. In an embodiment, avatar evolution can be based upon one or more of the following:

(1) experience points earned from watching/rating content;

(2) the type of content a user has previously watched;

(3) the frequency over time at which the user watches content; and

(4) competing with other users using games to gain points, new capabilities, new items, and so forth.

It is to be appreciated the preceding listing is merely illustrative and, thus, avatar evolution can be based upon other criteria while maintaining the spirit of the present principles.

In an embodiment, the visual representation of the avatar can change based upon all types of progression. New features, capabilities, content offers, other types of offers (e.g., meet actor X when you get to level Y), and so forth, could be extended to the user based upon this progression, thus further evolving the avatar.

A description of experience based progression will now be given, in accordance with an embodiment of the present principles. As used herein, experience based progression essentially involves evolving the avatar based upon the amount of experience obtained by the user or the avatar of the user.

In an embodiment, an experience based level progression might look something like the following. In practice, more levels would be required for better game dynamics.

Movie Viewer (level 0)

Movie Fan (level 1)

Movie Fanatic (level 2)

Best Boy (level 3)

Key Grip (level 4)

Director (level 5)

Producer (level 6)

In the above example, the user starts as a simple movie viewer and gets progressively more engaged to get a job in the movies and finally becoming a producer. Obviously, users could also start in other character roles and progress accordingly (e.g., a zombie, a zombie killer, a vampire hunter, a vampire, a romantic, an action aficionado, a sophisticate (indie movies and documentaries)). It is to be appreciated that the preceding character roles are merely illustrative and, thus, any character roles can be used in accordance with the teachings of the present principles, while maintaining the spirit of the present principles. There are lots of fun possibilities of how to progress a user. Again, the preceding merely represents examples.

In an embodiment, experience could be earned in a manner such as the following, where each level could be 2500 points (or any number of points, depending upon the implementation):

Watching Movies (2.5 hours)=50 points

Watching Movies (2 hours)=40 points

Watching Movies (1.5 hours)=30 points

Watching TV (60 minutes)=20 points

Watching TV (30 minutes)=10 points

Rating content=1 point

Other (e.g., we can have a quiz game or other opportunities to incorporate the avatar)=X points

The point allocation can be fine-tuned to ensure good game dynamics for the user. It is to be appreciated that the preceding point allocations and corresponding experiences are merely illustrative and, thus, other point allocations and experiences can also be used in accordance with the teachings of the present principles, while maintaining the spirit of the present principles.

A description will now be given of content type progression, in accordance with an embodiment of the present principles. As used herein, content type progression essentially involves evolving the avatar based upon the content watched and/or rated by the user. Moreover, content type progression can involve the user and/or the avatar earning and/or otherwise being provided with items based upon the content watched and/or rated by the user. Further, the items can be upgraded/changed as the avatar evolves. One or more of the preceding can thus be implemented with respect to content type progression.

In an embodiment, the user's content type progression could look like the following.

10 Vampire Movies watched->Character earns stake

10 Zombie Movies watched->Character earns a shotgun

10 Dramas watched->Character earns a heart

10 Romantic Comedies watched->Character earns a flower

5 movies including actors 6 degrees from Kevin Bacon watched->Character earns the 6 degrees from Kevin Bacon badge

5 movies including Natalie Portman watched->Character earns a Natalie Portman Badge Level 1

30 movies including Natalie Portman watched->Character earns a Natalie Portman Expert Badge or Stalker Badge if you have a sense of humor.

In this case, the character would earn items and the visual representation of the avatar would change based upon the types of content being watched. Items can potentially be redeemed or traded in for new and better items. This could be implemented by clicking the items or having a virtual store for redemption (e.g., free or discounted content or more virtual items).

In an embodiment, offers can be attached to the new item that is rendered for the avatar. If it seems that a user is acquiring items of a particular type “clothing”, offers can be generated in real life that pertain to such items. For example, if a user ends up acquiring a lot of avatar items that are baseball caps, offers concerning baseball teams or the like can be given to the user.

A description of frequency based progression will now be given, in accordance with an embodiment of the present principles. As used herein, frequency based progression essentially involves evolving the avatar based upon a frequency with which a user one or more of uses, watches, or purchases a particular application or content. Moreover, frequency based progression can involve evolving the avatar based on other frequencies as readily contemplated by one of ordinary skill in the art, given the teachings of the present principles provided herein.

In an embodiment, frequency based progression can look like the following.

The user has not entered the application for over a year and rarely purchases content. Accordingly, the avatar can grow a beard and look like it has been sleeping or sick (e.g., in bed, with a thermometer). Moreover, the avatar can lose muscle definition and look significantly less healthy.

The user has not entered the application for days and sometimes purchases content. Accordingly, the avatar shows a slight loss of muscle definition and looks a little less healthy.

The user frequently uses the application and purchases content. Accordingly, the avatar gets leaner and looks stronger.

In the preceding examples, the idea is to change the avatar visually based upon how often the user is using the application and purchasing content. Healthier avatars could be given more special offers or have different capabilities based upon this health status.

It is to be appreciated that the preceding are merely examples of frequency based progression and according effect on the avatar and, thus, other examples and effects can also be used in accordance with the teachings of the present principles, while maintaining the spirit of the present principles.

A description will now be given regarding competition based progression, in accordance with an embodiment of the present principles. As used herein, competition based progression essentially involves evolving the avatar based upon competition with other users. Moreover, competition based progression can involve the user and/or the avatar earning and/or otherwise being provided with items based upon the content watched by the user. Further, the items can be used to evolve the avatar. One or more of the preceding can thus be implemented with respect to competition based progression.

In an embodiment, the users competition based progression can look like the following.

Users compete to watch a television series the fastest. Finishing each episode, seasons, and all the seasons gains the user a certain number of points or items related to the content type they are watching. These points, items, and so forth can help to evolve the avatar further.

Thus, the aforementioned progressions, as well as any other progressions implemented in accordance with the teachings of the present principles, can be related to content consumption. Of course, the progressions can be unrelated to content consumption. These and other variations of the present principles are readily determined by one of ordinary skill in the art, given the teachings of the present principles provided herein, while maintaining the spirit of the present principles.

A description will now be given of some of the many attendant advantages/features of the present invention, some of which have been mentioned above. For example, one advantage/feature is a method that includes accessing a user profile for a user from a memory device. The method further includes generating an avatar for the user based upon the user profile. The method also includes changing the user profile based upon actions of the user relating to at least one of experience based progression, content type progression, frequency based progression, and competition based progression. The method additionally includes evolving an attribute of the avatar based upon a change in the user profile.

Another advantage/feature is the method as described above, wherein the experience based progression includes evolving the avatar based upon an amount of experience obtained by the user or the avatar of the user.

Yet another advantage/feature is the method as described above, wherein the content type progression includes evolving the avatar based upon content at least one of watched and rated by the user.

Still another advantage/feature is the method wherein the content type progression includes evolving the avatar based upon content at least one of watched and rated by the user as described above, and wherein the content type progression further includes providing at least one of the user and the avatar with items based upon the content at least one of watched and rated by the user.

Moreover, another advantage/feature is the method wherein the content type progression further includes providing at least one of the user and the avatar with items based upon the content at least one of watched and rated by the user as described above, and wherein the items evolve as the avatar evolves.

Further, another advantage/feature is the method as described above, wherein the frequency based progression includes evolving the avatar based upon a frequency with which the user one or more of uses, watches, and purchases a particular application or content.

Also, another advantage/feature is the method as described above, wherein the competition based progression includes evolving the avatar based upon competition with other users relating to content consumption.

Additionally, another advantage/feature is the method as described above, wherein the competition based progression includes providing the user with items based upon the content watched by the user and evolving the avatar based upon the items.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method, comprising:
accessing a user profile for a user from a memory device;
generating an avatar for the user based upon the user profile;
changing the user profile based upon actions of the user relating to at least one of experience based progression, content type progression, frequency based progression, and competition based progression; and
evolving an attribute of the avatar based upon a change in the user profile.

2. The method of claim 1, wherein the experience based progression comprises evolving the avatar based upon an amount of experience obtained by the user or the avatar of the user.

3. The method of claim 1, wherein the content type progression comprises evolving the avatar based upon content at least one of watched and rated by the user.

4. The method of claim 3, wherein the content type progression further comprises providing at least one of the user and the avatar with items based upon the content at least one of watched and rated by the user.

5. The method of claim 4, wherein the items evolve as the avatar evolves.

6. The method of claim 1, wherein the frequency based progression comprises evolving the avatar based upon a frequency with which the user one or more of uses, watches, and purchases a particular application or content.

7. The method of claim 1, wherein the competition based progression comprises evolving the avatar based upon competition with other users relating to content consumption.

8. The method of claim 1, wherein the competition based progression comprises providing the user with items based upon the content watched by the user and evolving the avatar based upon the items.

9. A system, comprising:
a memory device for storing a user profile for a user;
an avatar generator for generating an avatar for the user based upon the user profile;
a user profile manager for changing the user profile based upon actions of the user relating to at least one of experience based progression, content type progression, frequency based progression, and competition based progression; and
an avatar evolver for evolving an attribute of the avatar based upon a change in the user profile.

10. The system of claim 9, wherein the experience based progression comprises evolving the avatar based upon an amount of experience obtained by the user or the avatar of the user.

11. The system of claim 9, wherein the content type progression comprises evolving the avatar based upon content at least one of watched and rated by the user.

12. The system of claim 11, wherein the content type progression further comprises providing at least one of the user and the avatar with items based upon the content at least one of watched and rated by the user.

13. The system of claim 12, wherein the items evolve as the avatar evolves.

14. The system of claim 9, wherein the frequency based progression comprises evolving the avatar based upon a frequency with which the user one or more of uses, watches, and purchases a particular application or content.

15. The system of claim 9, wherein the competition based progression comprises evolving the avatar based upon competition with other users relating to content consumption.

16. The system of claim 9, wherein the competition based progression comprises providing the user with items based upon the content watched by the user and evolving the avatar based upon the items.

17. A non-transitory computer readable storage medium having computer executable code stored thereon for performing a method, the method comprising:
accessing a user profile for a user;
generating an avatar for the user based upon the user profile;
changing the user profile based upon actions of the user relating to at least one of experience based progression, content type progression, frequency based progression, and competition based progression; and
evolving an attribute of the avatar based upon a change in the user profile.
